(19) United States
(12) Patent Application Publication
(10) Pub. No.: US 2026/0099889 A1
(43) Pub. Date: Apr. 9, 2026

(54) SYSTEM AND METHOD FOR LLM-ASSISTED SURVEYS OF LAW

(71) Applicant: Thomson Reuters Enterprise Centre GmbH, Zug (CH)

(72) Inventors: Gayle May McElvain, Minneapolis, MN (US); Pan Du, Oakville (CA); Madeline Nicole Stewart Bowie, Eagan, MN (US); Merine Thomas, Eagan, MN (US); George A. Sanchez, Rosemount, MN (US); Ahsin Shabbir, Rochester Hills, MI (US)

(21) Appl. No.: 19/354,257

(22) Filed: Oct. 9, 2025

Related U.S. Application Data
(60) Provisional application No. 63/705,313, filed on Oct. 9, 2024.

(51) Int. Cl. G06Q 50/18

(52) U.S. Cl. CPC G06Q 50/18

(57) ABSTRACT

A survey of law system is provided, comprising: a retrieval module to reformulate a user query into additional queries that carry scope information of law titles and generate other queries from the user query; wherein the queries are applied to indirect and direct indices to generate indirect and direct ranking lists; a rank fusion module to generate a ranked listing of statutes from ranked statutes cited in the non-statutory sources and the direct ranking lists; a law identification module to generate a ranked listing of statutes that are directly relevant to answer the user query; and a survey generation module including a third LLM to generate answers to the user query for a plurality of jurisdictions from the ranked listing of directly relevant statutes.

### RELATED APPLICATIONS

This application is related to and claims priority to provisional application Ser. No. 63/705,313, filed on Oct. 9, 2024, entitled “LLM-ASSISTED SURVEYS OF LAW,” the entire contents of which being expressly incorporated herein by reference.

### FIELD

The present disclosure pertains to the field of artificial intelligence, and more specifically to a large language model (“LLM”) based system and method for generating summaries of legal topics across multiple jurisdictions.

### BACKGROUND

Traditional methods of creating surveys of the law aim to summarize critical information on a given legal issue, question, topic, or law in multiple jurisdictions. The collection phase often requires multiple stages of retrieval and ranking to identify potentially relevant documents in a coarse-to-fine manner. Summaries are then created by analyzing primary law and extracting information, key terms, sentences, or language to generate a summary of the relevant documents.

Creating a survey of the law has unique and challenging characteristics, including that surveys: (1) require collecting information about the law in each jurisdiction separately, and in multiple sources of the law in each jurisdiction, which presents linguistic diversity posing challenges for model design; (2) necessitate frequent re-evaluation of collected data due to frequent changes in the law; (3) are answer-driven, which requires systems to not only filter out irrelevant information but also identify specific answers and refrain from providing an answer when one does not exist; and (4) utilize well-structured data, where the structure itself can be answer-indicative.

Due to these unique aspects, conventional techniques used in traditional survey generation, which primarily focus on relevancy ranking and summarization, are inadequate for generating surveys of the law. As such, it is desirable to provide an LLM-assisted system and method for generating surveys of the law that address the inadequacies of the conventional techniques.

### SUMMARY

In one embodiment, the present disclosure provides a system for generating a survey of law, comprising: a structure guided retrieval module including a first large language model (“LLM”) configured to interpret an original query from a user, reformulate the original query into a plurality of additional queries that carry scope information of law titles from a legal data set accessible by the first LLM and generate a plurality of other queries from the original query; wherein the original query, the plurality of additional queries and the plurality of other queries are applied to a plurality of search indices including a plurality of indirect indices and a plurality of direct indices to generate a plurality of indirect ranking lists and a plurality of direct ranking lists, the plurality of indirect ranking lists each including non-statutory sources that each have a rank and cite to a statute, and the plurality of direct ranking lists each including statutory sources that each have a rank; a rank fusion module configured to generate a ranked listing of statutes from ranked statutes cited in the non-statutory sources and the plurality of direct ranking lists; an applicable law identification module including a second LLM configured to determine whether each statute in the ranked listing of statutes is directly relevant to an answer to the original query and generate a ranked listing of directly relevant statutes; and a survey generation module including a third LLM configured to generate a plurality of answers to the original query for a corresponding plurality of jurisdictions from the ranked listing of directly relevant statutes. In one aspect of this embodiment, the survey generation module further comprises a fourth LLM configured to respond to a topic-focused comparative summarization prompt by compiling the plurality of answers for the corresponding plurality of jurisdictions and a summary of the plurality of answers, each of the compiled plurality of answers includes a link to a statute. In another aspect, the first LLM generates titles of applicable laws which are used with the original query to reformulate the original query into the plurality of additional queries. In yet another aspect, the plurality of other queries are semantic queries. In a further aspect of this embodiment, the plurality of indirect indices includes a case opinions index, a case headnotes index, a case notes on decisions index and a secondary sources index. In a variation of this aspect, each index of the plurality of indirect indices supports both dense retrieval and keyword searching. In still another aspect, the plurality of direct indices includes a statute/regulation summaries index and a statute body text index. In another aspect, the system further comprises a bipartite graph-based transfer ranking module configured to transfer the ranks of the non-statutory sources of the plurality of indirect ranking lists to the ranked statutes cited in the non-statutory sources. In a variant of this aspect, the bipartite graph-based transfer ranking module transfers the ranks of the non-statutory sources to the statutes cited in the non-statutory sources by building a citation graph, creating an adjacency matrix of the graph, and iteratively propagating relevance between the non-statutory sources and the statutes cited in the non-statutory sources to either convergence or a predefined maximum number of iterations. In yet another aspect, the rank fusion module uses reciprocal rank fusion.

According to another embodiment, the present disclosure provides a method for generating a survey of law, comprising: reformulating, by a first large language model (“LLM”), an original query from a user into a plurality of additional queries that carry scope information of law titles from a legal data set accessible by the first LLM; generating, by the first LLM, a plurality of other queries from the original query; applying the original query, the plurality of additional queries and the plurality of other queries to a plurality of search indices including a plurality of indirect indices and a plurality of direct indices to generate a plurality of indirect ranking lists and a plurality of direct ranking lists, the plurality of indirect ranking lists each including non-statutory sources that each have a rank and cite to a statute, and the plurality of direct ranking lists each including statutory sources that each have a rank; generating a ranked listing of statutes from ranked statutes cited in the non-statutory sources and the plurality of direct ranking lists using rank fusion; determining, by a second LLM, whether each statute in the ranked listing of statutes is directly relevant to an answer to the original query; generating, by the second LLM, a ranked listing of directly relevant statutes; and generating, by a third LLM, a plurality of answers to the original query for a corresponding plurality of jurisdictions from the ranked listing of directly relevant statutes. In one aspect of this embodiment, the method further comprises responding, by a fourth LLM, to a topic-focused comparative summarization prompt by compiling the plurality of answers for the corresponding plurality of jurisdictions and a summary of the plurality of answers, each of the compiled plurality of answers includes a link to a statute. In another aspect, the first LLM generates titles of applicable laws which are used with the original query to reformulate the original query into the plurality of additional queries. In another aspect, the plurality of other queries are semantic queries. In yet another aspect, the plurality of indirect indices includes a case opinions index, a case headnotes index, a case notes on decisions index and a secondary sources index. In a variation of this aspect, each index of the plurality of indirect indices supports both dense retrieval and keyword searching. In still another aspect of this embodiment, the plurality of direct indices includes a statute/regulation summaries index and a statute body text index. In another aspect, the method further comprises transferring the ranks of the non-statutory sources of the plurality of indirect ranking lists to the ranked statutes cited in the non-statutory sources using bipartite graph-based transfer ranking. In a variant of this aspect, transferring the ranks includes building a citation graph, creating an adjacency matrix of the graph, and iteratively propagating relevance between the non-statutory sources and the statutes cited in the non-statutory sources to either convergence or a predefined maximum number of iterations. In another aspect, generating the ranked listing of statutes includes using reciprocal rank fusion.

In still another embodiment, the present disclosure provides a system for generating a survey of law, comprising: a memory including a plurality of large language models (“LLMs”) and a plurality of instructions; a controller coupled to the memory and configured to execute the instructions to perform a plurality of functions, including: reformulating, by a first LLM, an original query from a user into a plurality of additional queries that carry scope information of law titles from a plurality of data sources accessible by the first LLM; generating, by the first LLM, a plurality of other queries from the original query; applying the original query, the plurality of additional queries and the plurality of other queries to a plurality of search indices including a plurality of indirect indices and a plurality of direct indices to generate a plurality of indirect ranking lists each including non-statutory sources that each have a rank and a cite to a statute and a plurality of direct ranking lists each including statutory sources that each have a rank; generating a ranked listing of statutes from ranked statutes cited in the non-statutory sources and the plurality of direct ranking lists using rank fusion; determining, by a second LLM, whether each statute in the ranked listing of statutes is directly relevant to an answer to the original query; generating, by the second LLM, a ranked listing of directly relevant statutes; generating, by a third LLM, a plurality of answers to the original query for a corresponding plurality of jurisdictions from the ranked listing of directly relevant statutes; and presenting a results screen on a user interface, the results screen including the plurality of answers to the original query for the corresponding plurality of jurisdictions. In one aspect of this embodiment, the system further comprises responding, by a fourth LLM, to a topic-focused comparative summarization prompt by compiling the plurality of answers for the corresponding plurality of jurisdictions and a summary of the plurality of answers, each of the compiled plurality of answers includes a link to a statute. In another aspect, the controller is further configured to execute the instructions to perform transferring the ranks of the non-statutory sources of the plurality of indirect ranking lists to the ranked statutes cited in the non-statutory sources using bipartite graph-based transfer ranking.

### BRIEF DESCRIPTION OF THE DRAWINGS

The above-mentioned and other advantages and objects of this invention, and the manner of attaining them, will become more apparent, and the invention itself will be better understood, by reference to the following description of embodiments of the invention taken in conjunction with the accompanying drawings, wherein:

FIG. 1 is a block diagram of a system according to one embodiment of the present disclosure;

FIG. 2 is a screen shot of an example user interface according to one embodiment of the present disclosure;

FIG. 3 is a screen shot of a survey of the law response provided by the system according to the present disclosure;

FIGS. 4-6 are conceptual diagrams of an operational framework of the system according to the present disclosure; and

FIG. 7 is a conceptual diagram of an example of a statute case relationship used by a transfer ranking module of the system of the present disclosure.

### DETAILED DESCRIPTION

By way of overview, the system and method of the present disclosure include several innovations that enhance traditional approaches for generating surveys of law. As is further described below, the present system employs a structure-guided retrieval approach that enables the retriever to prioritize laws from predicted sections relevant to a given question. The system also uses a transfer-ranking method that extends the reliability of ranking results from linguistically ranker-compatible sources to less compatible sources. Additionally, the system described herein employs an LLM-as-grader strategy that is tuned to identify truly essential laws from highly relevant ones curated by retrievers and rankers, thereby mitigating passive hallucinations in the answer generator.

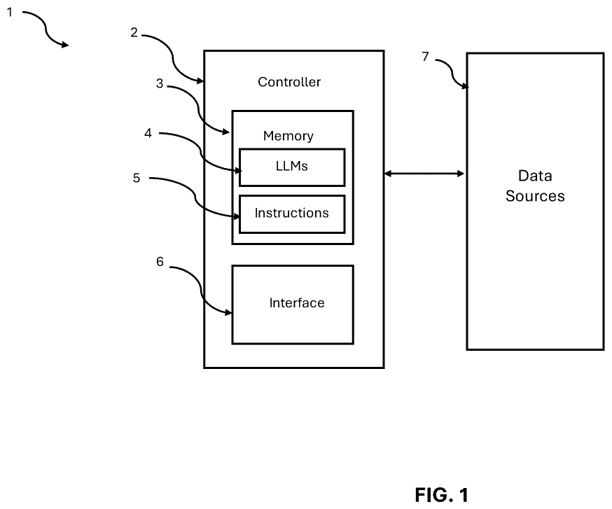

Referring now to FIG. 1, the system 1 generally includes a controller 2 having a memory 3 and a user interface 6. The memory 3 includes a plurality of large language models (“LLMs”) 4 and a plurality of instructions 5. The controller 2 is configured to communicate with a plurality of data sources 7. It should be understood that the system 1 may include a plurality of controllers 2 for performing the functions described herein. The controller 2 may communicate with the data sources 7 and/or the user interface 6 via one or more networks (not shown).

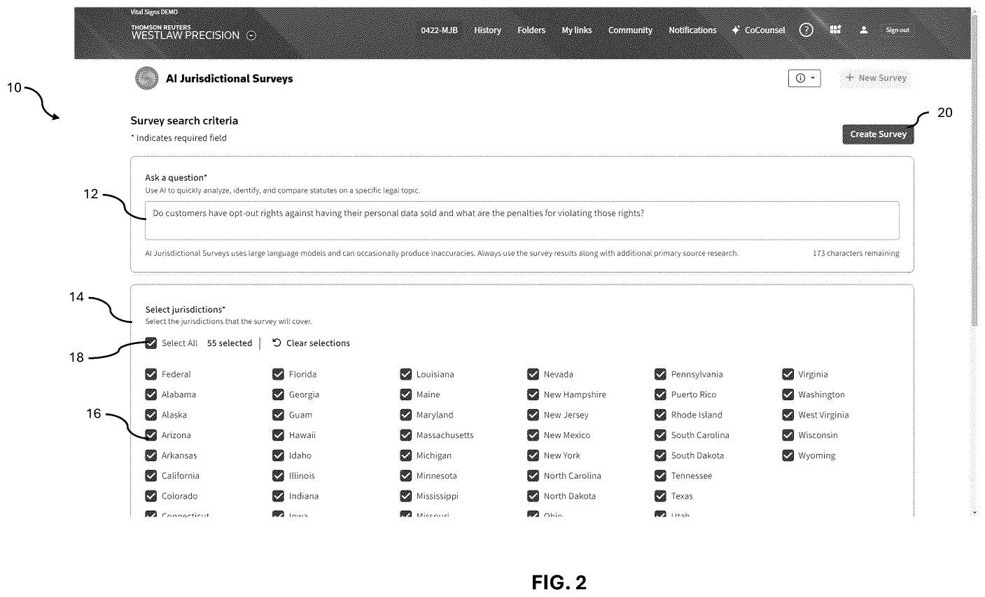

The system 1 of the present disclosure addresses the challenges of generating surveys of the law by combining the reasoning competence of generative large language models (“LLMs”) with informative signals extracted from high-value editorial content. An example jurisdictional survey of law may be a survey of data sharing opt out requirements in various jurisdictions. An example screen shot 10 generated by the user interface 6 for initiating a survey is shown in FIG. 2. A user may initiate the survey by inputting a prompt requesting a summary of opt out laws (including any associated penalties for violating the laws) in all 50 states together with federal, DC and territories. As shown, a prompt or question box 12 is provided as well as a jurisdiction selection box 14 with a plurality of check boxes 16 for selecting individual jurisdictions. A select all check box 18, in this example, is selected. After the user formulates the prompt or query 40 and selects the relevant jurisdictions, the user may click on the create survey icon 20 to initiate the survey. The system 1 responds by providing a survey composed of answers and corresponding citations for each jurisdiction and a summary of answers across jurisdictions.

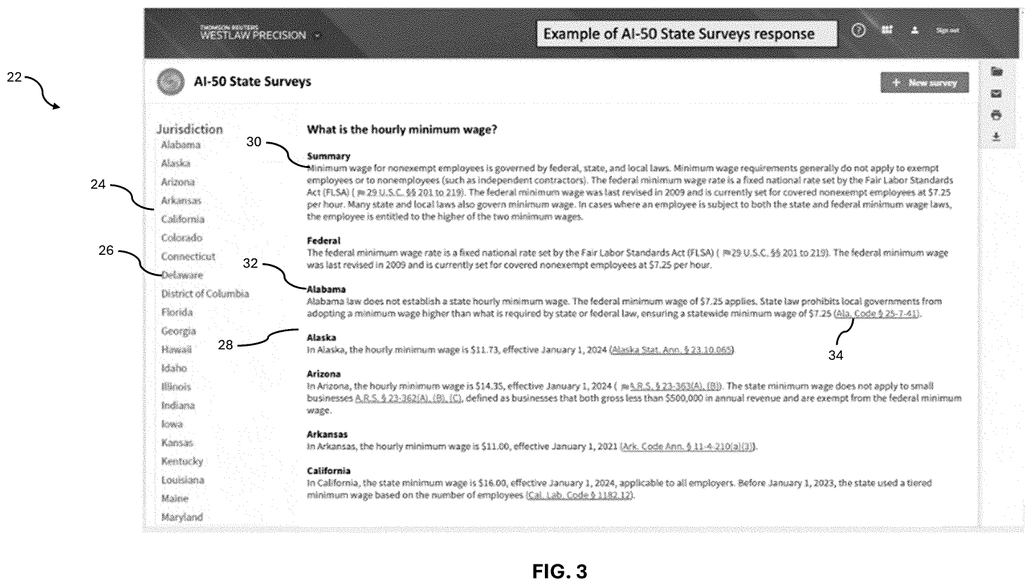

FIG. 3 provides an example response screen 22 to a survey prompt regarding hourly minimum wage laws. As shown, the response screen 22 provides a jurisdiction column 24 with links 26 to results for individual jurisdictions and a results box 28 with an overall summary 30 and a plurality of jurisdiction summaries 32, each including one or more statute links 34 to relevant laws in the jurisdiction.

The codified laws are organized in a hierarchical, tree-shaped structure. Each sub-tree delineates the applicable scope of the law at varying levels of granularity, with the sub-tree's title offering a rough semantic description of its scope. The deeper the sub-tree, the more precise the scope becomes for searching the applicable law, and the more challenging it is for an LLM to predict corresponding titles in the sub-tree for a given query. Fortunately, even the upper-level titles can be useful in guiding the search toward a more promising scope of the applicable laws.

As is further described below, given a query, the system first employs an LLM 46 to select the most likely law title from a predefined title set. The LLM 46 then uses the predicted title to expand the original query. Both the expanded query and the original query are used for searching across multiple content types or search indices, including statutes, regulations, headnotes, and cases. The top search results are then forwarded to a transfer-ranking module for finer-grained ranking. In this manner, structure-guided retrieval helps direct search efforts toward more promising scopes of the law, with the assistance of the LLM 46.

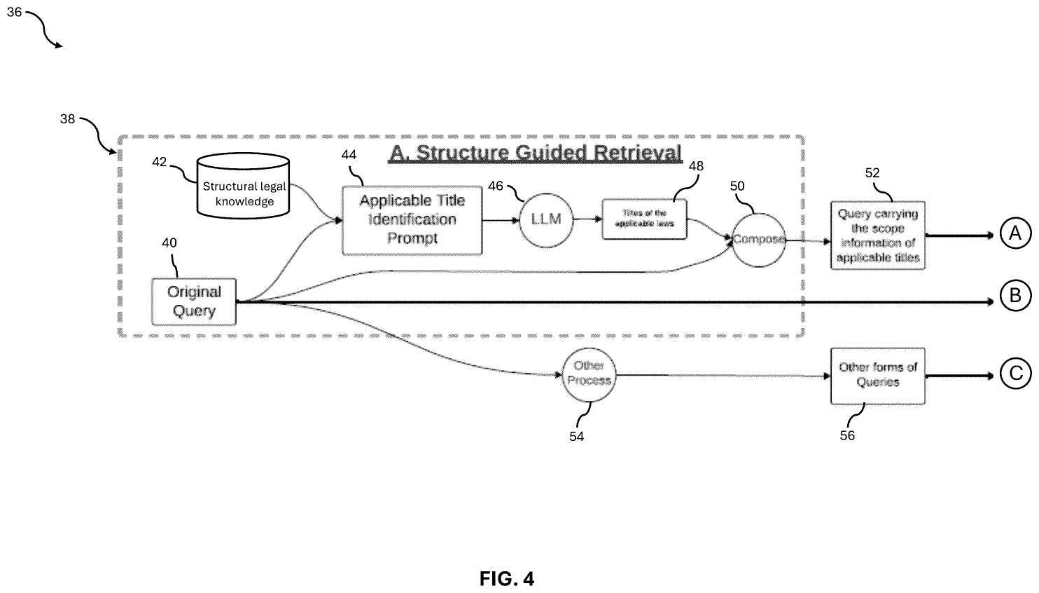

Referring now to FIGS. 4-6, an example operational framework of the system 1 according to the present disclosure is shown, which streamlines complex law survey generation workflows while improving overall accuracy and ease of use. The process 36 begins with a structure guided retrieval module 38 which uses the user-inputted original query 40 described above. The original query 40 is reformulated into multiple queries first, and the multiple queries are then submitted to multiple indices to collect relevant contents as is further described below.

In general, the requirement of retrieval and ranking of statutes and regulations (hereinafter, “statutes”) goes beyond relevancy in that the statutes should be essential or directly relevant to support answering the query 40. Many statutes may be topically relevant but directly relevant to the query 40. It is desirable to avoid missing directly relevant statutes as much as possible. As described herein, multiple indices and multiple forms of queries are used as leverage to increase the recall rate.

Multiple sources and multiple query forms assist in the collection of relevant materials of different content types. Some content types can be used directly (e.g., statute body text and statute summaries), and others such as cases, headnotes, and secondary sources cannot. The cited statutes may be used but the relevance of the cited statutes need to be re-accessed before being used. Once relevant statutes from multiple sources have been collected, a unified ranking list through rank fusion is used as described below to select a subset as evidence to generate the answer from.

High recall rate of the ranking results is intuitively achieved through collecting results from more sources using multiple query forms for a given query jurisdiction (state) pair. The original query 40 submitted by the user is used in the search of relevant statutes in case the system accidentally misinterprets the query intent during query reformulation. As indicated above, statutes are generally codified in a tree structure manually like a table of contents of a book for attorneys to look up. The system 1 helps select the potentially related subtitles of the given query to indicate the query intent. These subtitles may be used as a query tag along with the original query to restrict the search scope, or to guide the search toward a more promising scope.

Additionally, the system 1 uses an LLM to generate a hypothetical answer to the original query 40 and uses the hypothetical answer as a new query. In this way, even if the generated answer is wrong, the answer text should be topically relevant and some new keywords from the generated answer may be more useful to match answers than those in the original query 40.

Utilizing multiple data sources 7 greatly reduces the possibility that applicable laws are overlooked during survey generation. However, each data source 7 or type has unique linguistic characteristics, such as style, vocabulary, and syntactical structures. This would normally necessitate the design and training of separate machine learning models for each data source 7 or type to accommodate the differences, leading to significant cost increases. To address this challenge, the present disclosure provides a bipartite graph-based ranking algorithm that leverages the citation relationships between cases and statutes as is further described below. This algorithm allows transfer ranking results from sources 7 that are compatible with existing models to those where the models are less confident. For example, while the retrieval models of the present disclosure are specifically designed and trained for case corpora, equivalent models for statutes may not exist. By using relevance scores calculated by the case retrieval models, the system 1 of the present disclosure can propagate those scores onto statutes based on a case-statute citation graph as is further described below. This ranking algorithm effectively transfers the ranking capabilities from cases to statutes, providing more reliable statute ranking results without the need for a separate retrieval model designed and trained for statutes.

Referring back to FIG. 4, the original query 40 along with structural legal knowledge in database 42 is processed at step 44 to generate the applicable title identification prompt. The database 42 is a hierarchical title texts of statutes and regulations. The titles are naturally organized in a tree-like structure, where parent- child relationships represent coarse-to-fine semantic topics or concepts.

When a user asks a question, the system 1 begins by retrieving the root title and its immediate children. The LLM 46 is then prompted to reason about which subtopic (i.e., child title) is most likely to contain an answer. That chosen child title becomes the new root, and its children (i.e., the grandchild titles) form the next level of subtopics. The LLM 46 repeats this reasoning process to predict the most relevant topic at each level of the hierarchy.

The resulting hierarchical topic path helps narrow the search scope by providing structured legal knowledge as additional query information. This focused semantic context improves retrieval performance by guiding the search toward the most relevant areas of the statute or regulation corpus.

The title identification prompt 44 is provided to LLM 46 which is specifically designed for legal applications and makes use of citations between statutes and case law. The LLM 46 leverages structural legal knowledge to predict the most relevant statute or regulation title for a given question. Since the hierarchical title structure also semantically organizes the contents of statutes and regulations, incorporating the predicted title into the subsequent query helps narrow the search scope and improve retrieval precision.

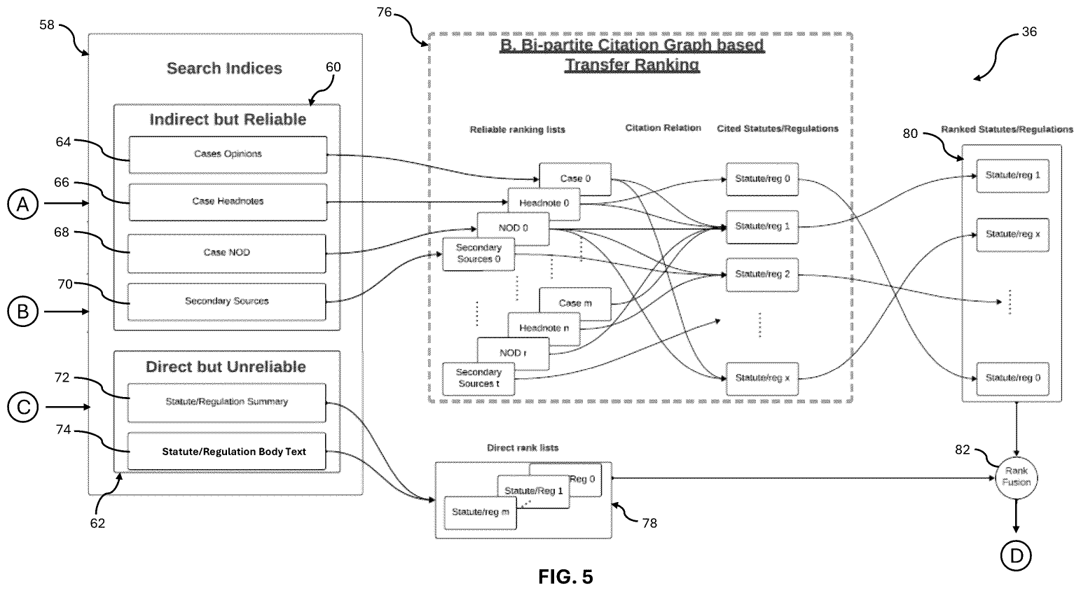

Thus, at step 48, the LLM 46 generates titles of the applicable laws which are used along with the original query 40 at step 50 to compose a query carrying the scope information of the applicable titles as indicated by box 52. At step 54, the system 1 generates other forms of queries (indicated by box 56) from the original query 40 for different indices for statutes, regulations, secondary sources, etc. as is further described below. The other forms of queries are semantic queries because the statutes are structured in a coded language which may not be searchable using natural language keyword searching. The queries carrying the scope information of applicable titles, the original query 40, and the other forms of queries are applied to search indices 58 as is further described below with reference to FIG. 5.

The search indices 58 include a group of indices 60 that are indirectly related to the actual statutes that are to be identified in response to the user's query 40, but have a well-structured search model to provide reliable results. The search indices 58 also includes a group of indices 62 that are directly related to the actual statutes.

The indices 60 include a case opinions index 64, a case headnotes index 66, a case notes on decisions (“NODs”—headnotes that have been linked to statutes) index 68, and a secondary sources index 70. The indices 62 include a statute/regulation summaries index 72 and a statute/regulation body text index 74. The case opinions index 64 is an index of case passages. The case headnotes index 66 and the case NODs index 68 are indices of headnotes. The secondary sources index 70 is an index of secondary sources including multiple content types such as ALR, AmJur, CJS, etc.

All of the indices 60 support both dense retrieval and keyword matching. The statute/regulation summaries index 72 is an index of statute summaries that supports keyword searching and the statute body text index 74 is an index of statute documents that supports keyword searching.

As a result of the queries described above being applied to the search indices 58, the indices 60 provide indirect ranking lists to a bipartite citation graph-based transfer ranking module 76 and the indices 62 provide direct rank lists as indicated by block 78. As is known in the mathematical field of graph theory, a bipartite citation graph is a graph whose vertices can be divided into two disjoint and independent sets U and V. In other words, every edge connects a vertex in U to a vertex in V. To generate a unified rank list to select the most promising statutes for generating an answer to the user's original query 40, the relevance ranks of the indirect ranking lists need to be transferred to the statutes first and then the ranks of multiple statute lists are fused as is further described below.

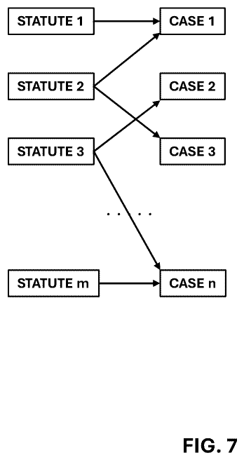

More specifically and referring to the example depicted in FIG. 7, the cases are ranked according to the raw and relatively accurate query-relevance measurements. The unique statutes are extracted from the most relevant case/headnote passages. The statute ranks will be derived through the citation relation between statutes and their occurrences in the top-n relevant cases. These statutes are the statutes cited by the most relevant opinion passages and headnotes (i.e., not all of the statutes cited by the full opinion are extracted, only those mentioned in the top N relevant paragraphs returned from the search indices 58). In this example, CASE 1 is the most relevant case to the query, CASE 2 is the second most relevant case, and CASE n is the least relevant case among the top-n relevant cases of the query. From the n cases, m statutes are identified. Some of these statutes may be relevant and others may not, depending on the local context where the statutes are cited in the case documents. As shown in FIG. 7, STATUTE 1 is cited by CASE 1, and STATUTE 2 is cited by both CASE 1 and CASE 3. Thus, it is likely that STATUTE 2 is more relevant than STATUTE 1. STATUTE 3 is cited in both CASE 2 and CASE n (n>3). Thus, STATUTE 3 is likely less relevant than STATUTE 2 because CASE 2 is less relevant than CASE 1 and CASE n is less relevant than CASE 3. In this example, it is unclear whether STATUTE 3 is less relevant than STATUTE 1.

It is known that STATUTE 2 could be more relevant than STATUTE 1 and STATUTE 3, and that STATUTE 2 is cited by both CASE 1 and CASE 3. In this circumstance, the relevance of CASE 3 may need to be adjusted accordingly, in terms of the case's capability of reflecting which statute is more relevant. If the relevance of cases is changed, that will definitely have an impact on that of the statutes again as demonstrated in the first step. To avoid an infinite loop of rank updates, the iteration process is formulated as a Markov process that will converge to a stable state eventually when the graph is properly constructed, thus preventing infinite rank-update cycles. Depending on how precise a rank is needed, how noisy the datasets are, and how large the computation budget is, in various embodiments a different maximum number of iterations may be used to approximate the converging state to a different degree. In certain embodiments, the core ranking algorithm builds the citation graph, creates the adjacency matrix of the graph, initializes the relevance prior of the cases and statutes, iteratively propagates the relevance signals between the statutes and cases, based on the citation relation, until it either converges or reaches the predefined maximum number of iterations, and returns the converged statute rank and case rank.

Mathematically, the process converges with unlimited iterations. In practice, however, a good approximation can be achieved in just a few iterations —for example, around five. If the relevance of the context where statutes or regulations are cited in cases and headnotes is confidently known, even fewer iterations can be sufficient; in the extreme case, only a single iteration may be used.

In this extreme scenario, the case or headnote relevance is effectively being used directly as the cited statute relevance. This may result in a much simpler alternative method that does not require iterative processing on the bipartite graph at all. Instead, it uses the case/headnote relevance as a proxy to rank the cited statutes. This approach may only be suitable when the relevance of the citation context is well established.

Referring back to FIG. 5, Case 0 cites to Statute/reg 1 and to Statute/reg x, Headnote 0 cites to Statute/reg 0 and to Statute/reg 1, NOD 0 cites to Statute/reg 1, Statute/reg 2 and to Statute/reg x, and Secondary Sources 0 cites to Statute/reg 2. At the bottom of the depicted ranking lists, Case m cites to Statute/reg 1, Headnote n cites to Statute/reg 2, NOD r cites to Statute/reg 1 and Secondary Sources t cites to one of the Statute/regs between Statute/reg 2 and Statute/reg x. As a result of the transfer ranking described above, in the ranked statutes/regulations depicted in block 80, Statute/reg 1 is listed as the most relevant, followed by Statute/reg x, other Statute/reg(s), Statute/reg 2, other Statute/reg(s) and finally Statute/reg 0.

The ranked statutes/regulations, along with the direct rank lists of block 78, are provided to a rank fusion module 82. In general, rank fusion is the process of combining multiple ranked lists of results into a single, more robust and reliable ranking to improve the effectiveness of an information retrieval system. In certain embodiments, the rank fusion module 82 uses reciprocal rank fusion, which may be considered a weighted voting method to derive a unified ranking score of a document based on the ranks or scores of the documents in its original rank lists. The higher the rank r is in its original list, the more weight (1/r or s/r where s is the original rank score) the document gets voted by its original list in the final ranking list.

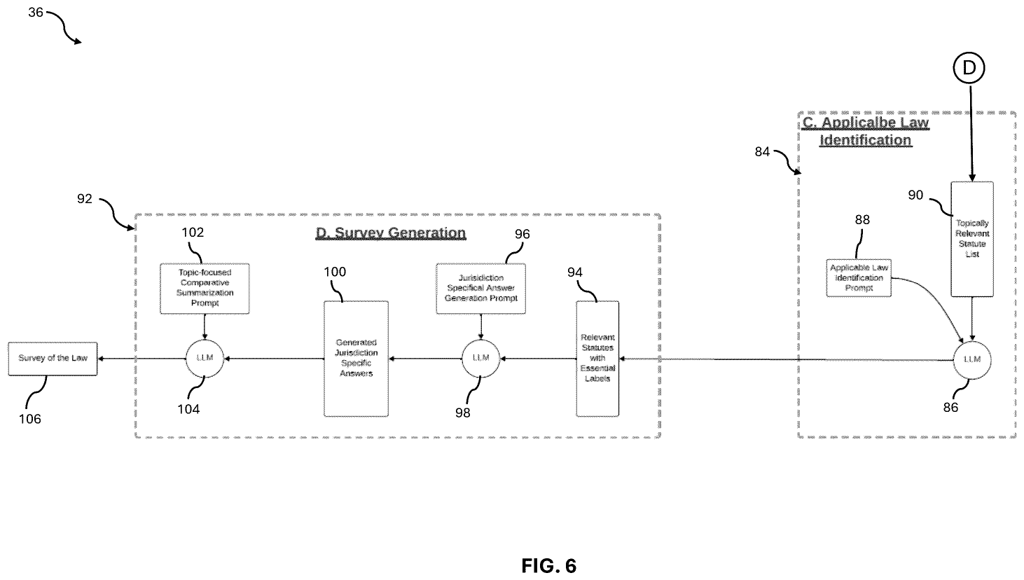

For example, assume there are three lists to be fused, and document a is ranked at the first place in each list, then the fused ranking score will be proportional to (1/1+1/1+1/1), which is the maximum score that one document can get from the fusion method. Suppose another document b is ranked at the 2,3,6 places respectively, then the fused score will be proportional to (1/2+1/3+1/6). Document b will get a lower score than document a since the weights it gets from source lists are lower than those of document a. The output of the rank fusion module 82 is provided to an applicable law identification module 84 as shown in FIG. 6.

As not all of the ranked statutes/regulations provided from the rank fusion module 82 will include an answer to the user's original query, it may be possible that the LLM 86 of the law identification module 84 will passively hallucinate (i.e., provide an answer where one does not exist). Both the retrievers and rankers are oriented towards topical relevance. They effectively condense relevant information at the top of the ranking list, thereby increasing the likelihood that applicable laws will appear among the top-ranked documents. However, relevance alone does not guarantee the presence of directly relevant documents needed to answer a query. Passive hallucinations can occur when no applicable law is present among the top-ranked documents, yet the LLM is still forced to generate an answer based on them.

To prevent such passive hallucinations during survey generation, the system of the present disclosure uses in-context learning to aid the LLM 86 in understanding the query and the provided ranked statutes/regulations (shown in FIG. 6 at block 90). The LLM 86 relies on the query, the relevant document, several demonstration examples, and specific instructions provided by subject matter experts (“SMEs”) (i.e., the applicable law identification prompt 88) to determine whether a relevant document could be directly relevant to answer the query. Its performance varies depending on the effectiveness of these instructions. To achieve better label quality (i.e., to actually get directly relevant documents at the top of the list), both SMEs and machine learning algorithms are employed to iteratively refine the instructions. The LLM 86 then verifies whether a document could contain an applicable law for the query by reasoning under the given instructions. The predicted labels are subsequently used as additional signals for answering the query and generating the final survey.

The output of the LLM 86 is provided to a survey generation module 92 as shown in FIG. 6. As indicated above, surveys of the law are dependent on the jurisdiction, meaning that answers to a legal question can vary across different regions. In general, the survey generation module 92 first produces an answer for each jurisdiction by leveraging the reasoning capabilities of an LLM 98. It then aggregates these answers to provide a summarized overview.

To generate jurisdiction-specific answers, the process begins by combining highly relevant documents (i.e., those most likely to contain applicable laws - indicated by block 94 in FIG. 6) with document-level metadata and task instructions (indicated by block 96 in FIG. 6). This combination serves as the input for the LLM 98. The LLM 98 will take in some top-ranked statutes/regulations, corresponding jurisdiction/state information, and some proper instructions from SMEs, and output an answer and corresponding citations for the jurisdiction/state based on the given statutes/regulations for the given query.

The LLM 98 reads the jurisdiction-specific documents, meta information, and task instructions to determine if the question can be answered within that jurisdiction. If applicable laws exist, the LLM 98 generates an answer; it refrains from providing one, otherwise. For each jurisdiction, the LLM 98 produces a unique answer (indicated by block 100), citing the applicable laws used to generate that answer. The applicable laws are listed as supporting materials, enabling the user to verify their applicability.

Finally, once all necessary answers are generated and the applicable laws are cited, in response to a topic-focused comparative summarization prompt 102 containing instructions from SMEs, an LLM 104 will compile the answers from all jurisdictions and generate a summary (block 106) based on them, as an overview of the survey. For a given query, the LLM 104 takes in the generated answer for each selected jurisdiction/state and generates an overview of the answers by summarizing the commons and highlighting the differences. In certain embodiments, the topic-focused comparative summarization may be omitted.

In certain embodiments, apart from the answer generated by the LLM 104, citations are generated as well in the answer context. These citations (see links 34 in FIG. 3) must come from the statutes/regulations that are provided through ranking. A post-citation extraction step is used to build links between the generated citation text and the documents provided for answer generation. In other embodiments, a relevance filtering component is provided to identify directly relevant documents from the topically relevant documents, to ensure the LLM 98 can refuse to generate an answer when no directly relevant documents exist in the provided documents.

One of ordinary skill in the art will realize that the embodiments provided can be implemented in hardware, software, firmware, and/or a combination thereof. For example, the controllers or processors disclosed herein may form a portion of a processing subsystem including one or more computing devices having memory, processing, and communication hardware. The controllers may be a single device or a distributed device, and the functions of the controllers may be performed by hardware and/or as computer instructions on a non-transient computer readable storage medium. For example, the computer instructions or programming code in the controller may be implemented in any viable programming language such as C, C++, C#, python, JAVA or any other viable high-level programming language, or a combination of a high-level programming language and a lower level programming language.

As used herein, the modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

It should be understood that the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements. The scope is accordingly to be limited by nothing other than the appended claims, in which reference to an element in the singular is not intended to mean “one and only one” unless explicitly so stated, but rather “one or more. ” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B or C may be present in a single embodiment; for example, A and B, A and C, B and C, or A and B and C.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S. C. 112(f), unless the element is expressly recited using the phrase “means for. ” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

What is claimed is:

1. A system for generating a survey of law, comprising:
a structure guided retrieval module including a first large language model (“LLM”) configured to interpret an original query from a user, reformulate the original query into a plurality of additional queries that carry scope information of law titles from a legal data set accessible by the first LLM and generate a plurality of other queries from the original query;
wherein the original query, the plurality of additional queries and the plurality of other queries are applied to a plurality of search indices including a plurality of indirect indices and a plurality of direct indices to generate a plurality of indirect ranking lists and a plurality of direct ranking lists, the plurality of indirect ranking lists each including non-statutory sources that each have a rank and cite to a statute, and the plurality of direct ranking lists each including statutory sources that each have a rank;
a rank fusion module configured to generate a ranked listing of statutes from ranked statutes cited in the non-statutory sources and the plurality of direct ranking lists;
an applicable law identification module including a second LLM configured to determine whether each statute in the ranked listing of statutes is directly relevant to an answer to the original query and generate a ranked listing of directly relevant statutes; and
a survey generation module including a third LLM configured to generate a plurality of answers to the original query for a corresponding plurality of jurisdictions from the ranked listing of directly relevant statutes.

2. The system of claim 1, wherein the survey generation module further comprises a fourth LLM configured to respond to a topic-focused comparative summarization prompt by compiling the plurality of answers for the corresponding plurality of jurisdictions and a summary of the plurality of answers, each of the compiled plurality of answers includes a link to a statute.

3. The system of claim 1, wherein the first LLM generates titles of applicable laws which are used with the original query to reformulate the original query into the plurality of additional queries.

4. The system of claim 1, wherein the plurality of other queries are semantic queries.

5. The system of claim 1, wherein the plurality of indirect indices includes a case opinions index, a case headnotes index, a case notes on decisions index and a secondary sources index.

6. The system of claim 5, wherein each index of the plurality of indirect indices supports both dense retrieval and keyword searching.

7. The system of claim 1, wherein the plurality of direct indices includes a statute/regulation summaries index and a statute body text index.

8. The system of claim 1, further comprising a bipartite graph-based transfer ranking module configured to transfer the ranks of the non-statutory sources of the plurality of indirect ranking lists to the ranked statutes cited in the non-statutory sources.

9. The system of claim 8, wherein the bipartite graph-based transfer ranking module transfers the ranks of the non-statutory sources to the statutes cited in the non-statutory sources by building a citation graph, creating an adjacency matrix of the graph, and iteratively propagating relevance between the non-statutory sources and the statutes cited in the non-statutory sources to either convergence or a predefined maximum number of iterations.

10. The system of claim 1, wherein the rank fusion module uses reciprocal rank fusion.

11. A method for generating a survey of law, comprising:
reformulating, by a first large language model (“LLM”), an original query from a user into a plurality of additional queries that carry scope information of law titles from a legal data set accessible by the first LLM;
generating, by the first LLM, a plurality of other queries from the original query;
applying the original query, the plurality of additional queries and the plurality of other queries to a plurality of search indices including a plurality of indirect indices and a plurality of direct indices to generate a plurality of indirect ranking lists and a plurality of direct ranking lists, the plurality of indirect ranking lists each including non-statutory sources that each have a rank and cite to a statute, and the plurality of direct ranking lists each including statutory sources that each have a rank;
generating a ranked listing of statutes from ranked statutes cited in the non-statutory sources and the plurality of direct ranking lists using rank fusion;
determining, by a second LLM, whether each statute in the ranked listing of statutes is directly relevant to an answer to the original query;
generating, by the second LLM, a ranked listing of directly relevant statutes; and
generating, by a third LLM, a plurality of answers to the original query for a corresponding plurality of jurisdictions from the ranked listing of directly relevant statutes.

12. The method of claim 11, further comprising responding, by a fourth LLM, to a topic-focused comparative summarization prompt by compiling the plurality of answers for the corresponding plurality of jurisdictions and a summary of the plurality of answers, each of the compiled plurality of answers includes a link to a statute.

13. The method of claim 11, wherein the first LLM generates titles of applicable laws which are used with the original query to reformulate the original query into the plurality of additional queries.

14. The method of claim 11, wherein the plurality of other queries are semantic queries.

15. The method of claim 11, wherein the plurality of indirect indices includes a case opinions index, a case headnotes index, a case notes on decisions index and a secondary sources index.

16. The method of claim 15, wherein each index of the plurality of indirect indices supports both dense retrieval and keyword searching.

17. The method of claim 11, wherein the plurality of direct indices includes a statute/regulation summaries index and a statute body text index.

18. The method of claim 11, further comprising transferring the ranks of the non-statutory sources of the plurality of indirect ranking lists to the ranked statutes cited in the non-statutory sources using bipartite graph-based transfer ranking.

19. The method of claim 18, wherein transferring the ranks includes building a citation graph, creating an adjacency matrix of the graph, and iteratively propagating relevance between the non-statutory sources and the statutes cited in the non-statutory sources to either convergence or a predefined maximum number of iterations.

20. The method of claim 11, wherein generating the ranked listing of statutes includes using reciprocal rank fusion.

21. A system for generating a survey of law, comprising:
a memory including a plurality of large language models (“LLMs”) and a plurality of instructions;
a controller coupled to the memory and configured to execute the instructions to perform a plurality of functions, including:
reformulating, by a first LLM, an original query from a user into a plurality of additional queries that carry scope information of law titles from a plurality of data sources accessible by the first LLM;
generating, by the first LLM, a plurality of other queries from the original query;
applying the original query, the plurality of additional queries and the plurality of other queries to a plurality of search indices including a plurality of indirect indices and a plurality of direct indices to generate a plurality of indirect ranking lists each including non-statutory sources that each have a rank and a cite to a statute and a plurality of direct ranking lists each including statutory sources that each have a rank;
generating a ranked listing of statutes from ranked statutes cited in the non-statutory sources and the plurality of direct ranking lists using rank fusion;
determining, by a second LLM, whether each statute in the ranked listing of statutes is directly relevant to an answer to the original query;
generating, by the second LLM, a ranked listing of directly relevant statutes;
generating, by a third LLM, a plurality of answers to the original query for a corresponding plurality of jurisdictions from the ranked listing of directly relevant statutes; and
presenting a results screen on a user interface, the results screen including the plurality of answers to the original query for the corresponding plurality of jurisdictions.

22. The system of claim 21, further comprising responding, by a fourth LLM, to a topic-focused comparative summarization prompt by compiling the plurality of answers for the corresponding plurality of jurisdictions and a summary of the plurality of answers, each of the compiled plurality of answers includes a link to a statute.

23. The system of claim 21, wherein the controller is further configured to execute the instructions to perform transferring the ranks of the non-statutory sources of the plurality of indirect ranking lists to the ranked statutes cited in the non-statutory sources using bipartite graph-based transfer ranking.
